(19) United States
(12) Patent Application Publication
(10) Pub. No.: US 2020/0376443 A1
(43) Pub. Date: Dec. 3, 2020

(54) SELECTIVELY PERMEABLE GRAPHENE OXIDE MEMBRANE

(71) Applicant: NITTO DENKO CORPORATION, Osaka (JP)

(72) Inventors: Shijun Zheng, San Diego, CA (US); Isamu Kitahara, San Diego, CA (US); Yuji Yamashiro, Osaka (JP); Weiping Lin, Carlsbad, CA (US); John Ericson, Poway, CA (US); Wanyun Hsieh, San Diego, CA (US); Ozair Siddiqui, Murrieta, CA (US); Peng Wang, San Diego, CA (US); Craig Roger Bartels, San Diego, CA (US); Makoto Kobuke, Osaka (JP); Shunsuke Noumi, Shiga (JP); Hiroki Fujioka, Osaka (JP)

(21) Appl. No.: 16/636,624

(22) PCT Filed: Aug. 2, 2018
(86) PCT No.: PCT/US2018/045052

§ 371 Date: Feb. 4, 2020

Related U.S. Application Data
(60) Provisional application No. 62/541,253, filed on Aug. 4, 2017.

(51) Int. Cl. B01D 69/10; B01D 71/02; B01D 67/00; B01D 69/02; C02F 1/44; C01B 32/198

(52) U.S. Cl. CPC B01D 69/10; B01D 71/021; B01D 71/024; B01D 67/0088; B01D 69/02; C02F 2103/08; C01B 32/198; B01D 2323/30; B01D 2325/04; B01D 2325/20; C02F 1/44

(57) ABSTRACT

Described herein are crosslinked graphene oxide and polycaroxylic acid based composite membranes that provide selective resistance for solutes while providing water permeability. Such composite membranes have a high water flux. The methods for making such membranes, and using the membranes for dehydrating or removing solutes from water are also described.

### CROSS REFERENCE TO RELATED APPLICATION

This application claims the benefit of U.S. Provisional Application 62/541,253, filed Aug. 4, 2017, which is incorporated by reference by its entirety.

### FIELD

The present embodiments are related to polymeric membranes, including membranes comprising graphene materials for uses such as water treatment, desalination of saline water, and/or water removal.

### BACKGROUND

Due to the increase of human population and water consumption coupled with limited fresh water resources on earth, technologies such as seawater desalination and water treatment/recycle to provide safe and fresh water have become more important to our society. The desalination process using reverse osmosis (RO) membrane is the leading technology for producing fresh water from saline water. Most of current commercial RO membranes adopt a thin-film composite (TFC) configuration consisting of a thin aromatic polyamide selective layer on top of a microporous substrate; typically a polysulfone membrane on non-woven polyester. Although these RO membranes can provide excellent salt rejection rate and higher water flux, thinner and more hydrophilic membranes are still desired to further improve energy efficiency of the RO process. Therefore, new membrane materials and synthetic methods are in high demand to achieve the desired properties as described above.

### SUMMARY

This disclosure relates to a graphene oxide (GO) membrane composition suitable for high water flux applications. The GO membrane composition may be prepared by using one or more water soluble cross-linkers, such as polycarboxylic acid. Methods of efficiently and economically making these GO membrane compositions are also described. Water can be used as a solvent in preparing these GO membrane compositions, which makes the membrane preparation process more environmentally friendly and more cost effective.

Some embodiments include a selectively permeable polymeric membrane such as a GO-based water permeable membrane, comprising: a porous support; and a composite coated on the porous support, comprising a crosslinked graphene oxide compound, wherein the crosslinked graphene oxide compound is formed by reacting a mixture comprising a graphene oxide compound and a crosslinker comprising a polycarboxylic acid; wherein the graphene oxide compound is suspended within the crosslinker and the weight ratio of the graphene oxide compound to the crosslinker is at least 0.1; and wherein the membrane exhibits a high water flux.

Some embodiments include a method of making a selectively water permeable membrane described herein, comprising: curing an aqueous mixture that is coated onto a porous support. In some embodiments, the curing is carried out at a temperature of 90° C. to 150° C. for 30 seconds to 3 hours to facilitate crosslinking within the aqueous mixture. The porous support is coated with the aqueous mixture by applying the aqueous mixture to the porous support, and repeating as necessary to achieve a layer having a thickness of about 30 nm to about 3000 nm. The aqueous mixture is formed by mixing a graphene oxide compound, a crosslinker comprising a polycarboxylic acid, such as poly(acrylic acid), and an additive, in an aqueous liquid.

Some embodiments include a method of removing a solute from an unprocessed solution comprising exposing the unprocessed solution to any of the water permeable membrane disclosed herein.

### BRIEF DESCRIPTION OF THE DRAWINGS

FIG. 1 is a depiction of a possible embodiment of a water permeable membrane without a salt rejection layer or a protective coating.

FIG. 2 is a depiction of a possible embodiment of a water permeable membrane without a salt rejection layer but with a protective coating.

FIG. 3 is a depiction of a possible embodiment of a water permeable membrane with a salt rejection layer but without a protective coating.

FIG. 4 is a depiction of a possible embodiment of a water permeable membrane with a salt rejection layer and a protective coating.

FIG. 5 is a depiction of a possible embodiment for the method of making a water permeable membrane.

FIG. 6 is a diagram depicting typical test cells in which the water permeable membrane embodiments are placed for water flux testing and salt rejection testing.

### DETAILED DESCRIPTION

### I. General

A selectively permeable membrane includes a membrane that is relatively permeable for one material, such as a particular fluid, but relatively impermeable for other materials, including other fluids or solutes. For example, a membrane may be relatively permeable to water or water vapor and relatively impermeable to ionic compounds or heavy metals. In some embodiments, the selectively permeable membrane can be permeable to water while being relatively impermeable to salts.

Unless otherwise indicated, when a compound or a chemical structure, such as graphene oxide, a crosslinker, or an additive, is referred to as being “optionally substituted,” it includes a compound or a chemical structure that either has no substituents (i.e., unsubstituted), or has one or more substituents (i.e., substituted). The term “substituent” has the broadest meaning known in the art, and includes a moiety that replaces one or more hydrogen atoms attached to a parent compound or structure. In some embodiments, a substituent may be any type of group that may be present on a structure of an organic compound, which may have a molecular weight (e.g., the sum of the atomic masses of the atoms of the substituent) of 15-50 g/mol, 15-100 g/mol, 15-150 g/mol, 15-200 g/mol, 15-300 g/mol, or 15-500 g/mol. In some embodiments, a substituent comprises, or consists of: 0-30, 0-20, 0-10, or 0-5 carbon atoms; and 0-30, 0-20, 0-10, or 0-5 heteroatoms, wherein each heteroatom may independently be: N, O, S, Si, F, Cl, Br, or I; provided that the substituent includes one C, N, O, S, Si, F, Cl, Br, or I atom. Examples of substituents include, but are not limited to, alkyl, alkenyl, alkynyl, heteroalkyl, heteroalkenyl, heteroalkynyl, aryl, heteroaryl, hydroxy, alkoxy, aryloxy, acyl, acyloxy, alkylcarboxylate, thiol, alkylthio, cyano, halo, thiocarbonyl, O-carbamyl, N-carbamyl, O-thiocarbamyl, N-thiocarbamyl, C-amido, N-amido, S-sulfonamido, N-sulfonamido, isocyanato, thiocyanato, isothiocyanato, nitro, silyl, sulfenyl, sulfinyl, sulfonyl, haloalkyl, haloalkoxyl, trihalomethanesulfonyl, trihalomethanesulfonamido, amino, etc.

For convenience, the term “molecular weight” is used with respect to a moiety or part of a molecule to indicate the sum of the atomic masses of the atoms in the moiety or part of a molecule, even though it may not be a complete molecule.

As used herein, the term “fluid communication” means that a fluid can pass through a first component and travel to and through a second component or more components regardless of whether they are in physical communication or the order of arrangement.

### II. Membrane

The present disclosure relates to water separation membranes where a highly hydrophilic composite material with low organic compound permeability and high mechanical and chemical stability may be useful to support a polyamide salt rejection layer in a reverse osmosis (RO) membrane. This membrane material may be suitable for solute removal from an unprocessed fluid, such as desalination from saline water, purifying drinking water, or waste water treatment. Some selective water permeable membranes described herein are crosslinked GO-based membranes having a high water flux, which may improve the energy efficiency of RO membranes and improve water recovery/separation efficiency. In some embodiments, the crosslinked GO-based membranes may comprise multiple layers, wherein at least one layer comprises a composite of a crosslinked graphene oxide (GO), or a GO-based composite. The crosslinked GO-based composite can be prepared by reacting a mixture comprising a graphene oxide compound and a crosslinker. It is believed that a crosslinked GO layer, with graphene oxide's hydrophilicity and selective permeability, may provide a membrane for broad applications where high water permeability with high selectivity of permeability is important. In addition, these selectively permeable membranes may also be prepared using water as a solvent, which can make the manufacturing process much more environmentally friendly and cost effective.

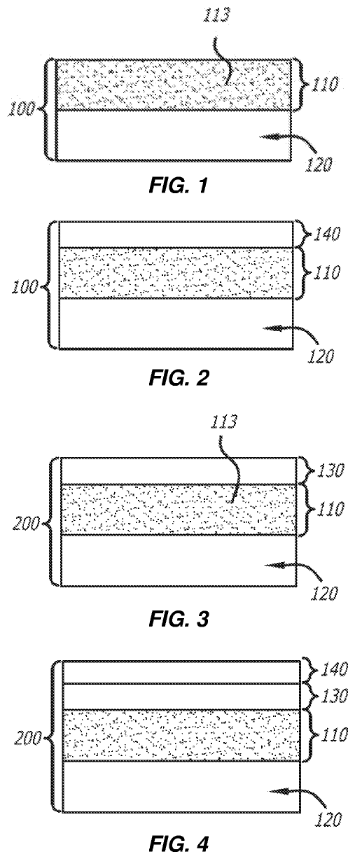

Generally, a selectively permeable membrane, such as a water permeable membrane, comprises a porous support and a composite coated onto or disposed on the support. For example, as depicted in FIG. 1, selectively permeable membrane 100 can include porous support 120. Crosslinked GO-based composite 110 is coated onto porous support 120.

In some embodiments, the porous support comprising a polymer or hollow fibers. The porous support may be sandwiched between two composite layers. The crosslinked GO-based composite may further be in fluid communication with the support.

An additional optional layer, such as a protective layer, may also be present. In some embodiments, the protective layer can comprise a hydrophilic polymer. A protective layer may be placed in any position that helps to protect the selectively permeable membrane, such as a water permeable membrane, from harsh environments, such as compounds which may deteriorate the layers, radiation, such as ultraviolet radiation, extreme temperatures, etc. For example, in FIG. 2, selectively permeable membrane 100, represented in FIG. 1, may further comprise protective coating 140, which is disposed on, or over, crosslinked GO-based composite 110.

A selectively permeable membrane, such as a water permeable membrane, may further comprise a salt rejection layer to help prevent salts from passing through the membrane. Some non-limiting examples of a selectively permeable membrane comprising a salt rejection layer are depicted in FIGS. 3 and 4. In FIGS. 3 and 4, membrane 200 comprises a salt rejection layer 130 that is disposed on crosslinked GO-based composite 110, which is disposed on porous support 120. In FIG. 4, selectively permeable membrane 200 further comprises protective coating 140 which is disposed on salt rejection 130.

In some embodiments, a fluid passing through the membrane travels through all the components regardless of whether they are in physical communication or their order of arrangement.

In some embodiments, the resulting membrane can allow the passage of water and/or water vapor, but resists the passage of solute. For some membranes the solute restrained can comprise ionic compounds such as salts or heavy metals.

A water permeable membrane, such as one described herein, can be used to remove water from a control volume. In some embodiments, a membrane may be disposed between a first fluid reservoir and a second fluid reservoir such that the reservoirs are in fluid communication through the membrane. In some embodiments, the first reservoir may contain a feed fluid upstream and/or at the membrane.

In some embodiments, the membrane can selectively allow liquid water or water vapor to pass through while keeping solute, or other liquid material from passing through. In some embodiments, the fluid upstream of the membrane can comprise a solution of water and solute. In some embodiments, the fluid downstream of the membrane may contain purified water or processed fluid. In some embodiments, as a result of the layers, the membrane may provide a durable desalination system that can be selectively permeable to water, and less permeable to salts. In some embodiments, as a result of the layers, the membrane may provide a durable reverse osmosis system that may effectively filter saline water, polluted water or feed fluids.

In some embodiments, the membrane exhibits a normalized volumetric water flow rate of about 10-1000 gal·ft⁻²·day⁻¹·bar⁻¹; about 20-750 gal·ft⁻²·day⁻¹·bar⁻¹; about 100-500 gal·ft⁻²·day⁻¹·bar⁻¹; about 10-50 gal·ft⁻²·day⁻¹·bar⁻¹; about 50-100 gal·ft⁻²·day⁻¹·bar⁻¹; about 10-200 gal·ft⁻²·day⁻¹·bar⁻¹; about 200-400 gal·ft⁻²·day⁻¹·bar⁻¹; about 400-600 gal·ft⁻²·day⁻¹·bar⁻¹; about 600-800 gal·ft⁻²·day⁻¹·bar⁻¹; about 800-1000 gal·ft⁻²·day⁻¹·bar⁻¹; at least about 10 gal·ft⁻²·day⁻¹·bar⁻¹, about 20 gal·ft⁻²·day⁻¹·bar⁻¹, about 100 gal·ft⁻²·day⁻¹·bar⁻¹, about 200 gal·ft⁻²·day⁻¹·bar⁻¹, or any normalized volumetric water flow rate in a range bounded by any of these values.

In some embodiments, a membrane may be selectively permeable. In some embodiments, the membrane may be an osmosis membrane. In some embodiments, the membrane may be a water separation membrane. In some embodiments, the membrane may be a reverse osmosis (RO) membrane. In some embodiments, the selectively permeable membrane may comprise multiple layers, wherein at least one layer contains a crosslinked GO-based composite.

### III. Porous Support

A porous support may be any suitable material in any suitable form upon which a layer, or layers of a crosslinked GO-based composite, may be deposited or disposed. In some embodiments, the porous support can comprise hollow fibers or porous material. In some embodiments, the porous support may comprise a porous material, such as a polymer or a hollow fiber. Some porous supports can comprise a non-woven fabric. In some embodiments, the polymer may be polyamide (Nylon), polyimide (PI), polyvinylidene fluoride (PVDF), polyethylene (PE), polypropylene (PPE), stretched polypropylene, polyethylene terephthalate (PET), polysulfone (PSF), polyether sulfone (PES), and/or mixtures thereof. In some embodiments, the polymer can comprise PET.

### IV. Crosslinked GO-Based Composite

The membranes described herein can comprise a crosslinked GO-based composite. Some membranes comprise a porous support and a crosslinked GO-based composite coated on the support. The crosslinked GO-based composite can be prepared by reacting a mixture comprising a graphene oxide compound and a crosslinker. The mixture that is reacted to form the crosslinked GO-based composite can comprise a graphene oxide compound and a crosslinker, such as a polycarboxylic acid. For example, the polycarboxylic acid can be poly(acrylic acid). In addition to the crosslinker, such as a polycarboxylic acid, an additional crosslinker such as lignin, polyvinyl alcohol, or a meta-phenylenediamine (MPD) may be present in the mixture. Additionally, an additive can be also present in the mixture. The reaction mixture may form covalent bonds, such as crosslinking bonds, between the constituents of the composite (e.g., graphene oxide compound, the crosslinkers, and/or additives). For example, a platelet of a graphene oxide compound may be bonded to another platelet; a graphene oxide compound may be bonded to a crosslinker (such as a polycarboxylic acid, lignin or MPD); a graphene oxide compound may be bonded to an additive; a crosslinker (such as a polycarboxylic acid, a lignin, or MPD) may be bonded to an additive, and etc. In some embodiments, any combination of graphene oxide compound, a crosslinker (such as a polycarboxylic acid, a lignin, or MPD), and additive can be covalently bonded to form a composite. In some embodiments, any combination of graphene oxide compound, a crosslinker (such as a polycarboxylic acid, a lignin, or MPD), and additive can be physically bonded to result in a material matrix.

The crosslinked GO-based composite can have any suitable thickness. For example, some crosslinked GO-based layers may have a thicknesses of about 5-5000 nm, about 30-3000 nm, about 30-4000 nm, about 50-4500 nm, about 100-4000 nm, about 1000-4000 nm, about 100-3000 nm, about 500-3500 nm, about 1000-3500 nm, about 1500-3500 nm, about 2500-3500nm, about 2500-3000 nm, about 5-2000 nm, about 50-2000 nm, about 5-1000 nm, about 1000-2000 nm, about 10-500 nm, about 50-500 nm, about 500-1000 nm, about 50-500 nm, about 50-400 nm, about 20-1,000 nm, about 5-40 nm, about 10-30 nm, about 20-60 nm, about 50-100 nm, about 70-120 nm, about 120-170 nm, about 150-200 nm, about 180-220 nm, about 200-250 nm, about 220-270 nm, about 250-300 nm, about 280-320 nm, about 300-400 nm, about 330-480 nm, about 400-600 nm, about 600-800 nm, about 800-1000 nm, about 50-500 nm, about 100-400 nm, about 100 nm, about 150 nm, about 200 nm, about 225 nm, about 250 nm, about 300 nm, about 350 nm, about 400 nm, about 500 nm, about 1000 nm, about 1500 nm, about 3000 nm, or any thickness in a range bounded by any of these values. Ranges or values listed above that encompass the following thicknesses are of particular interest: about 30 nm, about 225 nm, about 500 nm, about 1000 nm, and about 3000 nm.

### A. Graphene Oxide

In general, graphene-based materials have many attractive properties, such as a 2-dimensional sheet-like structure with extraordinary high mechanical strength and nanometer scale thickness. The graphene oxide (GO), an exfoliated oxidation product of graphite, can be mass produced at low cost. With its high degree of oxidation, graphene oxide has high water permeability and also exhibits versatility to be functionalized by many functional groups, such as amines or alcohols to form various membrane structures. Unlike traditional membranes, where the water is transported through the pores of the material, in graphene oxide membranes the transportation of water can be between the interlayer spaces. Graphene oxide's capillary effect can result in long water slip lengths that offer fast water transportation rate. Additionally, the membrane's selectivity and water flux can be controlled by adjusting the interlayer distance of graphene sheets, or by the utilization of different crosslinking moieties.

In the membranes disclosed, a graphene oxide material includes an optionally substituted graphene oxide compound. In some embodiments, the optionally substituted graphene oxide may contain a graphene which has been chemically modified, or functionalized. A modified graphene may be any graphene material that has been chemically modified, or functionalized. In some embodiments, the graphene oxide can be optionally substituted.

Functionalized graphene is a graphene oxide compound that includes one or more functional groups not present in graphene oxide, such as functional groups that are not OH, COOH or an epoxide group directly attached to a C-atom of the graphene base. Examples of functional groups that may be present in functionalized graphene include halogen, alkene, alkyne, cyano, ester, amide, or amine.

In some embodiments, at least about 99%, at least about 95%, at least about 90%, at least about 80%, at least about 70%, at least about 60%, at least about 50%, at least about 40%, at least about 30%, at least about 20%, at least about 10%, or at least about 5% of the graphene molecules may be oxidized or functionalized. In some embodiments, the graphene oxide compound is graphene oxide that is not functionalized. In some embodiments, graphene oxide can also include reduced graphene oxide. In some embodiments, graphene oxide compound can be graphene oxide, reduced-graphene oxide, functionalized graphene oxide, or functionalized and reduced-graphene oxide. The graphene oxide may provide selective permeability for gases, fluids, and/or vapors.

It is believed that there may be a large number (˜30%) of epoxy groups on GO, which may be readily reactive with hydroxyl groups at elevated temperatures (or with amine groups at room temperature or elevated temperatures to generate functionalized GO). It is also believed that GO sheets have an extraordinary high aspect ratio which provides a large available gas/water diffusion surface as compared to other materials, and it has the ability to decrease the effective pore diameter of any substrate supporting material to minimize contaminant infusion while retaining flux rates. It is also believed that the epoxy or hydroxyl groups increases the hydrophilicity of the materials, and thus contributes to the increase in water or water vapor permeability and selectivity of the membrane.

In some embodiments, the optionally substituted graphene oxide may be in the form of sheets, planes or flakes. In some embodiments, the graphene material may have a surface area of about 100-5000 m²/g, about 150-4000 m²/g, about 200-1000 m²/g, about 500-1000 m²/g, about 1000-2500 m²/g, about 2000-3000 m²/g, about 100-500 m²/g, about 400-500 m²/g, or any surface area in a range bounded by any of these values.

In some embodiments, the graphene oxide may be platelets having 1, 2, or 3 dimensions with size of each dimension independently in the nanometer to micron range. In some embodiments, the graphene may have a platelet size in any one of the dimensions, or may have a square root of the area of the largest surface of the platelet, of about 0.05-100 μm, about 0.05-50 μm, about 0.1-50 μm, about 0.5-10 μm, about 1-5 μm, about 0.1-2 μm, about 1-3 μm, about 2-4 μm, about 3-5 μm, about 4-6 μm, about 5-7 μm, about 6-8 μm, about 7-10 μm, about 10-15 μm, about 15-20 μm, about 20-50 μm, about 50-100 μm, about 60-80 μm, about 50-60 μm, about 25-50 μm, or any platelet size in a range bounded by any of these values.

In some embodiments, the graphene oxide material can comprise at least 70%, at least 75%, at least 80%, at least 85%, at least 90%, at least 95%, at least 97%, or at least 99% of graphene material having a molecular weight of about 5,000-200,000 Daltons (Da).

In some embodiments, the mass percentage of the graphene oxide relative to the total weight of the composite can be at least about 10 wt %, at least about 13 wt %, at least about 14 wt %, at least about 15 wt %, at least about 16%, about 10-80 wt %, about 10-75 wt %, about 10-70 wt %, about 10-65 wt %, about 10-60 wt %, about 10-50 wt %, about 10-40 wt %, about 10-20 wt %, about 20-40 wt %, about 20-35 wt %, about 11-55 wt %, about 11-40 wt %, about 11-30 wt %, about 12-30 wt %, about 13-40 wt %, about 13-35 wt %, about 13-25 wt %, about 10-15 wt %, about 12-17 wt %, about 12-14 wt %, about 13-15 wt %, about 14-16 wt %, about 15-17 wt %, about 16-18 wt %, about 15-20 wt %, about 17-23 wt %, about 20-25 wt %, about 23-28 wt %, about 25-30 wt %, about 30-40 wt %, about 35-45 wt %, about 40-50 wt %, about 45-55 wt %, or about 50-70 wt %, or any percentage in a range bounded by any of these values. Ranges above that encompass the following weight percentages of the graphene oxide compound, such as graphene oxide, are of particular interest: about 13.2 wt %, about 13.3 wt %, about 13.8 wt %, about 14.6 wt %, about 14.8 wt %, about 15.4 wt %, about 15.6 wt %, about 16.7 wt %, about 20 wt %, about 25 wt %, and about 34 wt %.

### B. Crosslinker

The composite, such as a crosslinked GO-based composite, is formed by reacting a mixture containing a graphene oxide compound with a crosslinker. The crosslinker can comprise a polycarboxylic acid, which may further comprise at least one additional crosslinker such as a biopolymer, a polyvinyl alcohol, or a meta-phenylenediamine.

In some embodiments, the crosslinker can comprise a polycarboxylic acid. The polycarboxylic acid can comprise polyacrylic acid, polymethacrylic acid, polymaleic acid, or the like. In some embodiments, polycarboxylic acid can comprise a polyacrylic acid. The average molecular weight of polycarboxylic acid may be about 10-4,000,000 Da, about 50-3,000,000 Da, about 100-1,250,000 Da, about 250-1,000,000 Da, about 500-500,000 Da, about 1,000-450,000 Da, about 1,100-250,000 Da, about 1,200-240,000 Da, about 1,250-200,000 Da, about 2,000-150,000 Da, about 2,100-130,000 Da, about 3,000-100,000 Da, about 5,000-83,000 Da, about 5,100-70,000 Da, about 8,000-50,000 Da, about 8,600-38,000 Da, about 8,700-30,000 Da, about 10,000-16,000 Da, or any molecular weight in a range bounded by any of these values, such as 2,000 Da, 4,000 Da, 130,000 Da, or 450,000 Da. Examples of commercially available polyacrylic acids include AQUASET-529 (Rohm & Haas, Philadelphia, Pa., USA), CRITERION 2000 (Kemira, Helsinki, Finland, Europe), NF1 (H. B. Fuller, St. Paul, Minn., USA), and SOKALAN (BASF, Ludwigshafen, Germany, Europe). SOKALAN, is a water-soluble polyacrylic copolymer of acrylic acid and maleic acid, having a molecular weight of approximately 4,000 Da. AQUASET-529 is a composition containing polyacrylic acid cross-linked with glycerol and sodium hypophosphite as a catalyst. CRITERION 2000 is thought to be an acidic solution of a partial salt of polyacrylic acid, having a molecular weight of approximately 2,000 Da. NF1 is a copolymer of monomers containing carboxylic acid and hydroxyl functional groups, as well as monomers with neither functional groups; NF1 also contains chain transfer agents, such as sodium hypophosphite or organophosphate catalysts.

In some composites, the crosslinker comprising polycarboxylic acid, can further comprise a biopolymer as an additional crosslinker. The biopolymer can comprise a plant-based polymer. The biopolymer can comprise a substance that can provide rigidity in the crosslinked composite. The biopolymer can comprise a substance that has multiple functional groups (e.g., hydroxyl groups) suitable for crosslinking. The plant-based polymer can comprise lignins, which are crosslinked phenolic polymers. The lignin can be sulfonated, such as a lignosulfonate, or a salt thereof such as sodium lignosulfonate (CAS: 8061-51-6), calcium lignosulfonate, magnesium lignosulfonate, potassium lignosulfonate, etc. In some embodiments, the crosslinker comprises sodium lignosulfonate.

In some embodiments, the weight average molecular weight of lignosulfonate may be about 10-500,000 Da, about 100-250,000 Da, about 1,000-140,000 Da, about 98,000 Da, about 1,000-10,000 Da, about 52,000 Da, or any molecular weight in a range bounded by any of these values.

In some embodiments, the number average molecular weight of lignosulfonate may be about 1,000-7,000 Da, about 1,000-3,000 Da, about 3,000-5,000 Da, about 5,000-7,000 Da, or any number average molecular weight in a range bounded by any of these values.

The lignin, such as lignosulfonate, may be present in any suitable amount. For example, with respect to the total weight of the composite, the lignin may be present in an amount of 0-50 wt %, about 0.1-50 wt %, 10-50 wt %, about 20-30 wt %, about 25-30 wt %, about 24-25 wt %, about 25-26 wt %, about 26-27 wt %, about 27-28 wt %, about 28-29 wt %, about 29-30 wt %, about 30-40 wt %, about 40-50 wt %, or any weight percentage in a range bounded by any of these values. Any of the above ranges which encompass any of the following percentages of the lignin, such as lignosulfonate, are of particular interest: 25 wt %, 26.7 wt %, 27.6 wt %, and 28.6 wt %.

In some embodiment, the crosslinker comprising polycarboxylic acid, can further comprise a polyvinyl alcohol as an additional crosslinker. The polyvinyl alcohol may be present in any suitable amount. For example, with respect to the total weight of the composite, the polyvinyl alcohol may be present in an amount of about 0-90 wt %, about 10-50 wt %, about 50-90 wt %, about 70-80 wt %, about 80-90 wt %, about 70-75 wt %, about 75-80 wt %, or about 80-85 wt %. In some embodiments, the crosslinker does not contain polyvinyl alcohol.

The molecular weight of the polyvinyl alcohol may be about 100-1,000,000 Da, about 10,000-500,000 Da, about 10,000-50,000 Da, about 50,000-100,000 Da, about 70,000-120,000 Da, about 80,000-130,000 Da, about 90,000-140,000 Da, about 90,000-100,000 Da, about 95,000-100,000 Da, about 89,000-98,000 Da, about 98,000 Da, about 89,000 Da, or any molecular weight in a range bounded by any of these values.

In some embodiments, the crosslinker comprising polycarboxylic acid, can further comprise meta-phenylenediamine as an additional crosslinker. The meta-phenylenediamine can be the optionally substituted meta-phenylenediamine as shown in Formula 1:

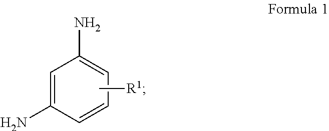

wherein R¹ is H, or an optionally substituted carboxylic acid, or a salt thereof. In some embodiments, the carboxylic acid salt can be a Na, K, or Li salt. In some embodiments, R¹ is H, CO₂H, CO₂Li, CO₂Na, and/or CO₂K. For example, the optionally substituted meta-phenylenediamine can be:

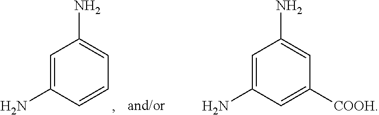 [SMILES: Nc1cccc(N)c1 ; Nc1cc(N)cc(C(=O)O)c1]

In some embodiments, the crosslinker can comprise one or more than one optionally substituted meta-phenylenediamine of Formula 1.

When the cross-linker is a salt, such as sodium salt, potassium salt, or lithium salt, the hydrophilicity of the resulting GO membrane could be increased, thereby increasing the total water flux. In some embodiments, the meta-phenylenediamine may form a cross-linkage containing a C—N bond between itself and at least one optionally substituted graphene oxide platelet by a ring opening reaction of an epoxide group on the graphene oxide with one of the amino groups in the diamine cross-linker of the meta-phenylenediamine. The meta-phenylenediamine can then be linked to another crosslinker moiety or another optionally substituted graphene oxide platelet to form crosslinked graphene oxide.

The meta-phenylenediamine may be present in any suitable amount, such as about 0-20 wt %, about 1-20 wt %, about 1-5 wt %, about 5-10 wt %, about 10-15 wt %, about 15-20 wt %, about 14-16 wt %, about 15-17 wt %, about 16-18 wt %, about 17-19 wt %, or about 18-20 wt %, based upon the total weight of the composite. Ranges that encompass, or are near, about 17 wt % or 17.2 wt % are of particular interest.

### C. Graphene Oxide Suspended Within Crosslinker(s)

In some embodiments, graphene oxide (GO) is suspended within the crosslinker(s). The moieties of the GO and the crosslinker may be bonded. The bonding may be chemical or physical. The bonding can be direct or indirect; such as in physical communication through at least one other moiety. In some composites, the graphene oxide and the crosslinkers may be chemically bonded to form a network of cross-linkages or a composite material. The bonding also can be physical to form a material matrix, wherein the GO is physically suspended within the crosslinkers.

### D. Weight Ratio of Graphene Oxide to Crosslinker

In some embodiments, the weight ratio of the graphene oxide (GO) to the crosslinker including all crosslinkers, (weight ratio=weight of graphene oxide+weight of all crosslinker) can be at least 0.1, about 0.1-4, about 0.12-1.0, about 0.15-0.5, about 0.16-0.17, about 0.16-0.6, about 0.5-0.6, about 0.16-0.4, about 0.167-0.35, about 0.17-0.2, about 0.1-0.2, about 0.2-0.3, about 0.3-0.4, about 0.4-0.5, about 0.5-0.6, about 0.6-0.7, about 0.16, about 0.167, about 0.174, about 0.2, about 0.348 (for example, 8.0 mg of graphene oxide, 15 mg of polyacrylic acid and 8 mg of lignin), about 0.4, about 0.515, or any weight ratio in a range bounded by any of these values. In some embodiments, the weight ratio of the graphene oxide to the crosslinker can be in a range of 0.16-0.6.

In some embodiments, the weight ratio of the crosslinker including all crosslinkers to the GO (weight ratio=weight of all crosslinkers+weight of graphene oxide) can be about 0.25-10, about 0.5-9, about 0.5-10, about 1-9, about 3-9, about 4-8, about 1-6, about 1-2, about 2-5, about 4-6, about 5-6, about 6-7, about 3-5, about 2-3, about 4.7, about 1.9, about 2.5, about 2.9, about 6, about 6.3, about 5.7, or about 5 (for example, 5 mg of crosslinker and 1 mg of optionally substituted graphene oxide), or any weight ratio in a range bounded by any of these values. In some membranes, the weight ratio of the crosslinker to the graphene oxide can be in a range of 1-7.

In some composites, the weight ratio of additional crosslinkers to polycarboxylic acid (weight ratio=weight of additional crosslinkers+weight of polycarboxylic acid) can be about 0.0-2.0, about 0.0-1.0, about 0.20-0.75, about 0.25-0.60, about 0.2-0.3, about 0.3-0.4, about 0.4-0.6, about 0.5-0.6, 0.5-7, such as 0, about 0.25, about 0.5, or about 0.53 (for example, 15 mg of polyacrylic acid per 8 mg of lignin), or any weight ratio in a range bounded by any of these values.

In some embodiments, the weight percentage of polycarboxylic acid relative to the total composition can be about 20-90 wt %, about 40-90 wt %, about 40-50 wt %, about 50-60 wt %, about 60-70 wt %, about 70-80 wt %, about 80-90 wt %, about 46.9 wt %, about 50 wt %, about 51.7 wt %, about 57.1 wt %, about 66 wt %, about 69.0 wt %, about 72.8 wt %, about 74.1 wt %, about 76.9 wt %, about 77.7 wt %, or about 83.3 wt %, or any weight percentage in a range bounded by any of these values.

It is believed that crosslinking the graphene oxide can enhance the resulting crosslinked GO-based composite's mechanical strength and water permeable properties (with high water flux) by creating strong chemical bonding between the moieties within the composite and wide channels between graphene platelets to allow water to pass through the platelets easily. In some embodiments, at least about 1%, about 5%, about 10%, about 20%, about 30%, about 40% about 50%, about 60%, about 70%, about 80%, about 90%, about 95%, or all of the graphene oxide platelets may be crosslinked. In some embodiments, the majority of the graphene material may be crosslinked. The amount of crosslinking may be estimated based on the weight of the cross-linker as compared to the total amount of graphene material.

### E. Additives

An additive or an additive mixture may, in some instances, improve the performance of the composite. Some crosslinked GO-based composites can also comprise an additive mixture. In some embodiments, the additive mixture can comprise borate salt, calcium chloride, silane-based compound, silica nanoparticles, polyethylene glycol, or any combination thereof. The silane-based compound can comprise a tetraethyl orthosilicate (TEOS) derivative, an optionally substituted aminoalkylsilane, or the like. In some embodiments, any of the moieties in the additive mixture may also be bonded with the material matrix. The bonding can be physical or chemical (e.g., covalent). The bonding can be direct or indirect.

Some additive mixtures can comprise calcium chloride. In some embodiments, calcium chloride is about 0-2 wt %, about 0-1.5 wt %, about 0-1 wt %, about 0.4-1.5 wt %, about 0.4-0.8 wt %, about 0.6-1 wt %, about 0.8-1.2 wt %, or about 0-0.5 wt % of the weight of the composite, such as 0 wt %, or any weight percentage in a range bounded by any of these values.

In some embodiments, the additive mixture can comprise a borate salt. In some embodiments, the borate salt comprises a tetraborate salt for example K₂B₄O₇, Li₂B₄O₇, or Na₂B₄O₇. In some embodiments, the borate salt can comprise K₂B₄O₇. In some embodiments, the weight percentage of borate salt based upon the total weight of the composite may be in a range of about 0-20 wt %, about 0.5-15 wt %, about 1-10 wt %, about 4-8 wt %, about 6-10 wt %, about 8-12 wt %, about 10-14 wt %, about 1-10 wt %, or about 0 wt %, or any weight percentage in a range bounded by any of these values.

In some embodiments, the silane-based compound can comprise a tetraethyl orthosilicate (TEOS) derivative. In some embodiments, the silane-based compound can comprise a group with structure of Formula 2:

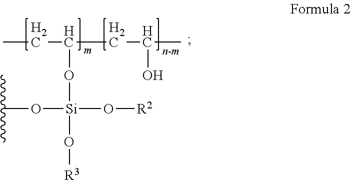

wherein, when bonded to the graphene oxide, R² and R³ can be independently H, CH₃, C₂H₅, or a polymer; n and m can be independently 0, 1, 2, 3, 4, 5, 6, 7, 8, 9, 10, 11, or 12, provided that n≥m; and the polymer is selected from the polymer materials disclosed herein that can be attached at R² or R³ position.

In some embodiments, the silane-based compound can comprise an optionally substituted aminoalkylsilane having structure of Formula 3:

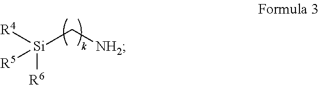

wherein R⁴, R⁵, and R⁶ can be independently —O-C₁₋₆ alkyl; and k is 3, 4, 5, or 6. In some embodiments, the optionally substituted aminoalkylsilane can comprise:

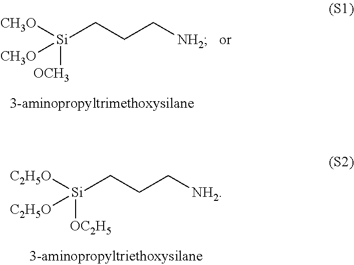

In some embodiments, the weight percentage of the silane-based group relative to the total composite can be about 0-15 wt %, about 0-10 wt %, about 6-7 wt %, about 7-8 wt %, such as about 0 wt %, about 6.3 wt %, about 6.7 wt %, about 7.4 wt %, about 7.7 wt %, or about 10 wt %, or any weight percentage in a range bounded by any of these values.

The additive or the additive mixture can comprise silica nanoparticles. In some embodiments, at least one other additive is present with the silica nanoparticles. In some embodiments, the silica nanoparticles may have an average size of about 5-200 nm, about 6-100 nm, about 6-50 nm, about 6-40 nm, about 7-50 nm, about 7-40 nm, about 7-20 nm, about 5-9 nm, about 5-15 nm, about 10-20 nm, about 15-25 nm, about 18-22 nm, or any size in a range bounded by any of these values. Of particular interest are ranges recited above that encompass the following particle sizes: about 7 nm, about 20 nm, and about 40 nm. The average size for a set of nanoparticles can be determined by taking the average volume and then determining the diameter associated with a comparable sphere which displaces the same volume to obtain the average size.

In some embodiments, the silica nanoparticles are about 0-15 wt %, about 0-10 wt %, about 0-5 wt %, about 1-10 wt %, about 0.1-3 wt %, about 2-4 wt %, about 3-5 wt %, about 4-6 wt %, about 3-4 wt %, about 5-7 wt %, about 6-7 wt %, about 7-9 wt %, about 8-10 wt %, about 9-11 wt %, about 10-12 wt %, about 3-7 wt %, or about 0-7 wt %, of the total weight of the composite, or any range bounded by any of these values. Of particular interest are any ranges above that encompass any of the following values: about 0 wt %, about 3.1 wt %, about 3.3 wt %, about 3.7 wt %, about 6.3 wt %, about 6.7 wt %, about 6.9 wt %, and about 10 wt %.

The additive or the additive mixture can further comprise polyethylene glycol. In some embodiments, the polyethylene glycol is about 0-30 wt %, about 0-20 wt %, about 0-15 wt %, 0-10 wt %, about 0-5 wt %, about 1-5 wt %, about 5-10 wt %, about 10-15 wt %, about 15-20 wt %, about 20-25 wt %, about 25-30 wt %, about 9-10 wt %, about 10-11 wt %, or about 10 wt % of the total weight of the composite.

### V. Salt Rejection Layer

Some membranes further comprise a salt rejection layer, e.g. disposed on the crosslinked GO-based composite that is coated on the support. Some salt rejection layers can give the membrane low salt permeability. A salt rejection layer may comprise any material that is suitable for preventing or reducing the passage of ionic compounds, or salts. In some embodiments, the salt rejected, removed, or partially removed, can comprise KCl, MgCl₂, CaCl₂, NaCl, K₂SO₄, Mg₂SO₄, CaSO₄, or Na₂SO₄. In some embodiments, the salt rejected, removed, or partially removed, can comprise NaCl. Some salt rejection layers comprise a polymer, such as a polyamide or a mixture of polyamides. In some embodiments, the polyamide can be a polyamide made from an amine (e.g. meta-phenylenediamine, para-phenylenediamine, ortho-phenylenediamine, piperazine, polyethylenimine, polyvinylamine, or the like) and an acyl chloride (e.g. trimesoyl chloride, isophthaloyl chloride, or the like). In some embodiments, the amine can be meta-phenylenediamine. In some embodiments, the acyl chloride can be trimesoyl chloride. In some embodiments, the polyamide can be made from a meta-phenylenediamine and a trimesoyl chloride (e.g. by a polymerization reaction of meta-phenylenediamine and trimesoyl chloride).

### VI. Protective Coating.

Some membranes may further comprise a protective coating. For example, the protective coating can be disposed on top of the membrane to protect it from the environment. The protective coating may have any composition suitable for protecting a membrane from the environment, Many polymers are suitable for use in a protective coating such as one or a mixture of hydrophilic polymers, e.g. polyvinyl alcohol (PVA), polyvinyl pyrrolidone (PVP), polyethylene glycol (PEG), polyethylene oxide (PEO), polyoxyethylene (POE), polyacrylic acid (PAA), polymethacrylic acid (PMMA) and polyacrylamide (PAM), polyethylenimine (PEI), poly(2-oxazoline), polyethersulfone (PES), methyl cellulose (MC), chitosan, poly (allylamine hydrochloride) (PAH) and poly (sodium 4-styrene sulfonate) (PSS), and any combinations thereof. In some embodiments, the protective coating can comprise PVA.

### VII. Methods of Fabricating Membranes.

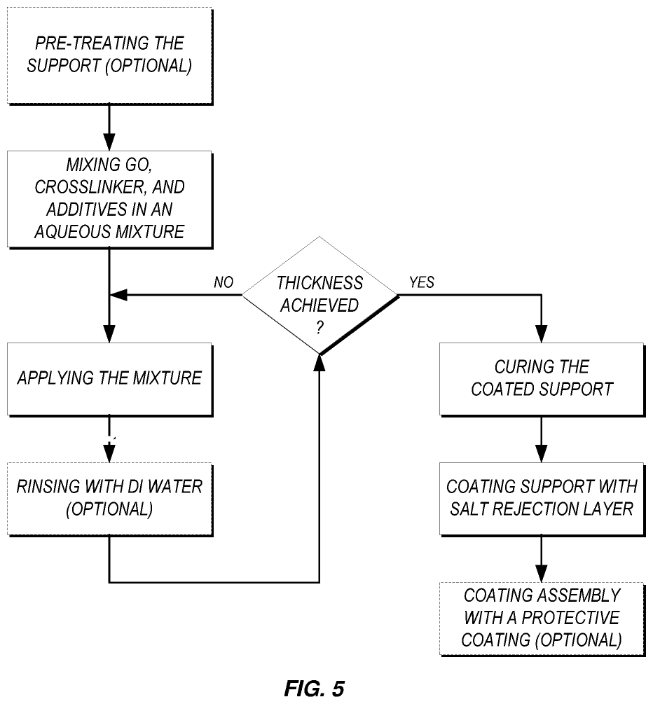

Some embodiments include methods for making the selectively permeable membrane, such as a water permeable membrane, comprising: (a) mixing the graphene oxide compound, the crosslinker comprising polycarboxylic acid, and optionally with an additional crosslinker, such as lignin, and the additive in an aqueous mixture; (b) applying the mixture to a porous support; (c) repeating step (b) as necessary to achieve the desired thickness; and (d) curing the coated support. Some methods include coating the porous support with a composite. In some embodiments, the method optionally comprises pre-treating the porous support. In some embodiments, the method can further comprise applying a salt rejection layer. Some methods also include applying a salt rejection layer on the resulting assembly, followed by additional curing of the resulting assembly. In some methods, a protective layer can also be placed on the assembly. An example of a possible method embodiment of making an aforementioned membrane is shown in FIG. 5.

In some embodiments, the step of mixing an aqueous mixture of graphene oxide material, crosslinker comprising polycarboxylic acid, and additives can be accomplished by dissolving appropriate amounts of graphene oxide material, crosslinker, and additives (e.g. borate salt; calcium chloride; TEOS; an optionally substituted aminoalkylsilane, such as 3-aminopropyltrimethoxysilane or 3-aminopropyltriethoxysilane; or silica nanoparticles) in water. In some embodiments, mixing the crosslinker comprising polycarboxylic acid can further comprise mixing one or more additional crosslinkers, in the same aqueous solution. The additional crosslinker added to in mixture can comprise a lignin, polyvinyl alcohol, meta-phenylenediamine, or any combinations thereof. The lignin can comprise a sulfonated lignin, such as a lignosulfonate or a salt thereof, such as sodium lignosulfonate, calcium lignosulfonate, magnesium lignosulfonate, potassium lignosulfonate, etc. Some methods comprise mixing at least two separate aqueous mixtures, e.g., a graphene oxide based mixture and a crosslinker and additive based mixture, then mixing appropriate mass ratios of the mixtures together to achieve the desired result. Other methods comprise creating one aqueous mixture by dissolving appropriate amounts of graphene oxide material, crosslinker, and additives within the same mixture. In some embodiments, the mixture can be agitated at temperatures and times sufficient to ensure uniform dissolution of the solute. The process results in a coating mixture that can be coated onto the support and reacted to form the composite.

In some embodiments, the porous support can be optionally pre-treated to aid in the adhesion of the composite layer to the porous support. For example, an aqueous solution of polyvinyl alcohol can be applied to the porous support and then dried. For some solutions, the aqueous solution can comprise about 0.01 wt %, about 0.02, about 0.05 wt %, or about 0.1 wt % PVA. In some embodiments, the pretreated support can be dried at a temperature of about 25° C., about 50° C., about 65° C., or about 75° C., for 2 minutes, 10 minutes, 30 minutes, 1 hour, or until the support is dry.

In some embodiments, applying the mixture to the porous support can be done by methods known in the art for creating a layer of desired thickness. In some embodiments, applying the coating mixture to the substrate can be achieved by vacuum immersing the substrate into the coating mixture first, and then drawing the solution onto the substrate by applying a negative pressure gradient across the substrate until the desired coating thickness can be achieved. In some embodiments, applying the coating mixture to the substrate can be achieved by blade coating, spray coating, dip coating, die coating, or spin coating. In some embodiments, the method can further comprise gently rinsing the substrate with deionized water after each application of the coating mixture to remove excess loose material. In some embodiments, the coating is done such that a composite layer of a desired thickness is created. The desired thickness of the composite layer can be in a range of about 5-3000 nm, about 30-3000 nm, 5-2000 nm, about 10-2000 nm, about 5-1000 nm, about 1000-2000 nm, about 10-500 nm, about 500-1000 nm, about 100-1500 nm, about 100-1500 nm, about 50-500 nm, about 500-1500nm, about 50-400 nm, about 50-150 nm, about 100-200 nm, about 150-250 nm, about 200-300 nm, about 200-250 nm, about 250-350 nm, about 300-400 nm, about 400-500 nm, about 400-600 nm, about 10-200 nm, about 10-100 nm, about 10-50 nm, about 20-40 nm, about 20-50 nm, or any thickness in a range bounded by any of these values. Ranges that encompass the following thicknesses are of particular interest: about 30 nm, about 100 nm, about 200 nm, about 225 nm, about 250 nm, about 300 nm, about 500 nm, about 1000 nm, or about 1500 nm, or about 3000 nm. In some embodiments, the number of layers can be in a range of about 1-250, about 1-100, about 1-50, about 1-20, about 1-15, about 1-10, or about 1-5. This process results in a fully coated substrate, or a coated support.

For some methods, curing the coated support can then be done at temperatures and times sufficient to facilitate crosslinking between the moieties of the aqueous mixture deposited on the porous support. In some embodiments, the coated support can be heated at a temperature of about 45-200° C., about 90-170° C., about 90-150° C., about 100° C., about 110° C., or about 140° C. In some embodiments, the coated support can be heated for a duration of at least about 30 seconds, at least about 1 minute, at least about 5 minutes, at least about 6 minutes, at least about 15 minutes, at least about 30 minutes, at least 45 minutes, up to about 1 hour, up to about 1.5 hours, up to about 3 hours; with the time required generally decreasing for increasing temperatures. In some embodiments, the substrate can be heated at about 110° C. for about 30 minutes or at about 140° C. for 6 minutes. In some embodiments, the substrate can be heated at about 100° C. for about 3 minutes. This process results in a cured membrane.

In some embodiments, the method for fabricating membranes can further comprise applying a salt rejection layer to the membrane or a cured membrane to yield a membrane with a salt rejection layer. In some embodiments, the salt rejection layer can be applied by dipping the cured membrane into a solution of precursors in mixed solvents. In some embodiments, the precursors can comprise an amine and an acyl chloride. In some embodiments, the precursors can comprise meta-phenylenediamine and trimesoyl chloride. In some embodiments, the concentration of meta-phenylenediamine can be in a range of about 0.01-10 wt %, about 0.1-5 wt %, about 5-10 wt %, about 1-5 wt %, about 2-4 wt %, about 4 wt %, about 2 wt %, or about 3 wt %. In some embodiments, the trimesoyl chloride concentration can be in a range of about 0.001-1 vol %, about 0.01-1 vol %, about 0.1-0.5 vol %, about 0.1-0.3 vol %, about 0.2-0.3 vol %, about 0.1-0.2 vol %, or about 0.14 vol %. In some embodiments, the mixture of meta-phenylenediamine and trimesoyl chloride can be allowed to rest for a sufficient amount of time such that polymerization can take place before the dipping occurs. In some embodiments, the method comprises resting the mixture at room temperature for about 1-6 hours, about 5 hours, about 2 hours, or about 3 hours. In some embodiments, the method comprises dipping the cured membrane in the coating mixture, e.g. after resting, for about 15 seconds to about 15 minutes; about 5 seconds to about 5 minutes, about 10 seconds to about 10 minutes, about 5-15 minutes, about 10-15 minutes, about 5-10 minutes, or about 10-15 seconds.

In other embodiments, the salt rejection layer can be applied by coating the cured membrane in separate solutions of aqueous meta-phenylenediamine and a solution of trimesoyl chloride in an organic solvent. In some embodiments, the meta-phenylenediamine solution can have a concentration in a range of about 0.01-10 wt %, about 0.1-5 wt %, about 5-10 wt %, about 1-5 wt %, about 2-4 wt %, about 4 wt %, about 2 wt %, or about 3 wt %. In some embodiments, the trimesoyl chloride solution can have a concentration in a range of about 0.001-1 vol %, about 0.01-1 vol %, about 0.1-0.5 vol %, about 0.1-0.3 vol %, about 0.2-0.3 vol %, about 0.1-0.2 vol %, or about 0.14 vol %. In some embodiments, the method comprises dipping the cured membrane in the aqueous meta-phenylenediamine for a period of about 1 second to about 30 minutes, about 15 seconds to about 15 minutes; or about 10 seconds to about 10 minutes. In some embodiments, the method then comprises removing excess meta-phenylenediamine from the cured membrane. In some embodiments, the method then comprises dipping the cured membrane into the trimesoyl chloride solution for a period of about 30 seconds to about 10 minutes, about 45 seconds to about 2.5 minutes, or about 1 minute. In some embodiments, the method comprises subsequently drying the resultant assembly in an oven to yield a membrane with a salt rejection layer. In some embodiments, the cured membrane can be dried at about 45-200° C. for a period about 5-20 minutes, at about 75-120° C. to for a period of about 5-15 minutes, or at about 90° C. for about 10 minutes. This process results in a membrane with a salt rejection layer.

In some embodiments, the method for fabricating a membrane can further comprise subsequently applying a protective coating on the membrane. In some embodiments, the applying a protective coating comprises adding a hydrophilic polymer layer. In some embodiments, applying a protective coating comprises coating the membrane with a polyvinyl alcohol aqueous solution. Applying a protective layer can be achieved by methods such as blade coating, spray coating, dip coating, spin coating, and etc. In some embodiments, applying a protective layer can be achieved by dip coating of the membrane in a protective coating solution for about 1-10 minutes, about 1-5 minutes, about 5 minutes, or about 2 minutes. In some embodiments, the method further comprises drying the membrane at a temperature of about 75-120° C. for about 5-15 minutes, or at about 90° C. for about 10 minutes. This process results in a membrane with a protective coating.

### VIII. Methods of Controlling Water or Solute Content

A water permeable membrane described herein may be used in methods of extracting liquid water from an unprocessed aqueous solution containing dissolved solutes, for applications such as pollutant removal or desalination. For example, a method for removing a solute from an unprocessed solution can comprise exposing the unprocessed solution to a water permeable membrane described herein. The method further comprises passing the unprocessed solution through the membrane, whereby the water is allowed to pass through while solutes are retained, thereby reducing the solute content of the resulting water.

During the above process, a water permeable membrane can have a first aqueous solution (or unprocessed liquid) within the pores of the porous support, which has not passed through the composite, and a second aqueous solution in contact with a surface of the composite opposite the porous support, which has passed through the composite and has a reduced salt concentration. Thus, the first aqueous solution and the second aqueous solution have different concentrations of a salt.

The unprocessed water containing solute may be passed through the membrane by a number of methods, such as by applying a pressure gradient across the membrane. Applying a pressure gradient can be accomplished by supplying a means of producing head pressure across the membrane. In some embodiments, the head pressure can be sufficient to overcome osmotic back pressure.

In some embodiments, providing a pressure gradient across the membrane can be achieved by producing a positive pressure in the first reservoir, producing a negative pressure in the second reservoir, or producing a positive pressure in the first reservoir and producing a negative pressure in the second reservoir. In some embodiments, a means of producing a positive pressure in the first reservoir can be accomplished by using a piston, a pump, a gravity drop, and/or a hydraulic ram. In some embodiments, a means of producing a negative pressure in the second reservoir can be achieved by applying a vacuum or withdrawing fluid from the second reservoir.

### EMBODIMENTS The following embodiments are specifically contemplated.

### Embodiment 1

A water permeable membrane comprising:

a porous support; and

a composite coated on the porous support, comprising a crosslinked graphene oxide compound, wherein the crosslinked graphene oxide compound is formed by reacting a mixture comprising a graphene oxide compound and a crosslinker comprising a polycarboxylic acid;

wherein the graphene oxide compound is suspended within the crosslinker and the weight ratio of the graphene oxide compound to the crosslinker is at least 0.1; and

wherein the membrane exhibits a high water flux.

### Embodiment 2

The water permeable membrane of embodiment 1, wherein the support is a non-woven fabric comprising polyamide, polyimide, polyvinylidene fluoride, polyethylene, polyethylene terephthalate, polysulfone, polyether sulfone, stretched polypropylene, polyethylene or a combination thereof.

### Embodiment 3

The water permeable membrane of embodiment 1 or 2, wherein the graphene oxide compound comprises a graphene oxide, reduced-graphene oxide, functionalized graphene oxide, functionalized and reduced-graphene oxide, or a combination thereof.

### Embodiment 4

The water permeable membrane of embodiment 3, wherein the graphene oxide compound is graphene oxide.

### Embodiment 5

The water permeable membrane of embodiment 1, 2, 3, or 4, wherein the crosslinker is a poly(acrylic acid).

### Embodiment 6

The water permeable membrane of embodiment 1, 2, 3, 4, or 5, wherein the crosslinker further comprises an additional crosslinker which comprises lignin, polyvinyl alcohol, meta-phenylenediamine, or a combination thereof.

### Embodiment 7

The water permeable membrane of embodiment 6, wherein the lignin comprises one or more of a ligano sulfonate salt comprising sodium lignosulfonate, calcium lignosulfonate, magnesium lignosulfonate, potassium lignosulfonate, or a combination thereof.

### Embodiment 8

The water permeable membrane of embodiment 6 or 7, wherein the weight ratio of additional crosslinker to polycarboxylic acid is 0 to about 1.

### Embodiment 9

The water permeable membrane of embodiment 1, 2, 3, 4, 5, 6, 7, or 8, wherein the weight ratio of the crosslinker to the graphene oxide compound is about 0.5 to about 9.

### Embodiment 10

The water permeable membrane of embodiment 1, 2, 3, 4, 5, 6, 7, 8, or 9, wherein the composite further comprises an additive mixture comprising CaCl₂, borate salt, tetraethyl orthosilicate, an optionally substituted aminoalkylsilane, silica nanoparticles, polyethylene glycol, or a combination thereof.

### Embodiment 11

The water permeable membrane of embodiment 10, wherein the CaCl₂ is 0 wt % to about 1.5 wt % of the composite.

### Embodiment 12

The water permeable membrane of embodiment 10 or 11, wherein the borate salt comprises K₂B₄O₇, Li₂B₄O₇, Na₂B₄O₇, or a combination thereof.

### Embodiment 13

The water permeable membrane of embodiment 12, wherein the borate salt is 0 wt % to about 20 wt % of the composite.

### Embodiment 14

The water permeable membrane of embodiment, 10, 11, 12, or 13, wherein the tetraethyl orthosilicate is 0 wt % to about 10 wt %.

### Embodiment 15

The water permeable membrane of embodiment, 10, 11, 12, 13, or 14, wherein the optionally substituted aminoalkylsilane is 3-aminopropyltrimethoxysilane, 3-aminopropyltriethoxysilane, or a combination thereof.

### Embodiment 16

The water permeable membrane of embodiment 10, 11, 12, 13, 14, or 15, wherein the combined weight of tetraethyl orthosilicate and optionally substituted aminoalkylsilane is 0 wt % to about 10 wt % of the composite.

### Embodiment 17

The water permeable membrane of embodiment 10, 11, 12, 13, 14, 15, or 16, wherein the silica nanoparticles are 0 wt % to about 10 wt % of the composite, and wherein the average size of the nanoparticles is about 5 nm to about 200 nm.

### Embodiment 18

The water permeable membrane of embodiment 1, 2, 3, 4, 5, 6, 7, 8, 9, 10, 11, 12, 13, 14, 15, 16, or 17, further comprising a salt rejection layer to reduce a salt permeability of the membrane.

### Embodiment 19

The water permeable membrane of embodiment 18, wherein the salt is NaCl.

### Embodiment 20

The water permeable membrane of embodiment 18 or 19, wherein the salt rejection layer is disposed on the composite.

### Embodiment 21

The water permeable membrane of embodiment 18, 19, or 20, wherein the salt rejection layer comprises a polyamide prepared by reacting a mixture containing meta-phenylenediamine and trimesoyl chloride.

### Embodiment 22

The water permeable membrane of embodiment 1, 2, 3, 4, 5, 6, 7, 8, 9, 10, 11, 12, 13, 14, 15, 16, 17, 18, 19, 20, or 21, wherein the composite is a layer having a thickness of about 30 nm to about 3000 nm.

### Embodiment 23

The water permeable membrane of embodiment 1, 2, 3, 4, 5, 6, 7, 8, 9, 10, 11, 12, 13, 14, 15, 16, 17, 18, 19, 20, 21, or 22, having a thickness of about 30 nm to about 4000 nm.

### Embodiment 24

The water permeable membrane of embodiment 1, 2, 3, 4, 5, 6, 7, 8, 9, 10, 11, 12, 13, 14, 15, 16, 17, 18, 19, 20, 21, 22, or 23, having water flux which is greater than about 5 gfs at 120 minutes and at a pressure of 50 psi.

### Embodiment 25

The water permeable membrane of embodiment 1, 2, 3, 4, 5, 6, 7, 8, 9, 10, 11, 12, 13, 14, 15, 16, 17, 18, 19, 20, 21, 22, or 23, having water flux which is greater than about 10 gfs at 120 minutes and at a pressure of 50 psi.

### Embodiment 26

The water permeable membrane of embodiment 1, 2, 3, 4, 5, 6, 7, 8, 9, 10, 11, 12, 13, 14, 15, 16, 17, 18, 19, 20, 21, 22, or 23, having water flux which is greater than about 90 gfs at 120 minutes and at a pressure of 225 psi.

### Embodiment 27

The water permeable membrane of embodiment 1, 2, 3, 4, 5, 6, 7, 8, 9, 10, 11, 12, 13, 14, 15, 16, 17, 18, 19, 20, 21, 22, or 23, having about 8% to about 100% rejection of NaCl at 225 psi pressure.

### Embodiment 28

The water permeable membrane of embodiment 1, 2, 3, 4, 5, 6, 7, 8, 9, 10, 11, 12, 13, 14, 15, 16, 17, 18, 19, 20, 21, 22, or 23, having more than about 40% rejection of NaCl at 225 psi pressure.

### Embodiment 29

The water permeable membrane of embodiment 1, 2, 3, 4, 5, 6, 7, 8, 9, 10, 11, 12, 13, 14, 15, 16, 17, 18, 19, 20, 21, 22, or 23, having about 90% to about 100% rejection of NaCl at 225 psi pressure.

### Embodiment 30

A method of making a water permeable membrane comprising:

curing an aqueous mixture that is coated onto a porous support;

wherein the aqueous mixture that is coated onto the porous support is cured at a temperature of 90° C. to 150° C. for 30 seconds to 3 hours to facilitate crosslinking within the aqueous mixture;

wherein the porous support is coated with the aqueous mixture by applying the aqueous mixture to the porous support, and repeating as necessary to achieve a layer having a thickness of about 30 nm to about 3000 nm; and

wherein the aqueous mixture is formed by mixing a graphene oxide material, a crosslinker comprising a polycarboxylic acid, and an additive, in an aqueous liquid.

### Embodiment 31

The method of embodiment 30, wherein the crosslinker comprising polycarboxylic acid further comprises an additional crosslinker comprising a lignin, polyvinyl alcohol, meta-phenylenediamine, or a combination thereof.

### Embodiment 32

The method of embodiment 31, wherein the lignin comprises one or more of a ligano sulfonate salt comprising sodium lignosulfonate, calcium lignosulfonate, magnesium lignosulfonate, potassium lignosulfonate, or a combination thereof.

### Embodiment 33

The method of embodiment 30, 31, or 32, wherein the additive mixture comprises CaCl₂, borate salt, tetraethyl orthosilicate, 3-aminopropyltrimethoxysilane, 3-aminopropyltriethoxysilane, silica nanoparticles, or a combination thereof.

### Embodiment 34

The method of embodiment 30, 31, or 32, the water permeable membrane is further coated with a salt rejection layer and the resultant assembly is cured at 45° C. to 200° C. for 5 minutes to 20 minutes.

### Embodiment 35

A method of removing solute from an unprocessed solution comprising exposing the unprocessed solution to the water permeable membrane of embodiment 1, 2, 3, 4, 5, 6, 7, 8, 9, 10, 11, 12, 13, 14, 15, 16, 17, 18, 19, 20, 21, 22, or 23.

### Embodiment 36

The method of embodiment 35, wherein the unprocessed solution is passed through the water permeable membrane.

### Embodiment 37

The method of embodiment 36, wherein the unprocessed solution is passed through the water permeable membrane by applying a pressure gradient across the water permeable membrane.

### EXAMPLES

It has been discovered that embodiments of the selectively permeable membranes described herein have improved performance as compared to other selectively permeable membranes. These benefits are further demonstrated by the following examples, which are intended to be illustrative of the disclosure only, but are not intended to limit the scope or underlying principles in any way.

### Example 1.1.1: Preparation of a Coating Mixture

Preparation of a GO Solution: GO was prepared from graphite using the modified Hummers method. Graphite flakes (2.0 g) (Sigma Aldrich, St. Louis, Mo., USA, 100 mesh) were oxidized in a mixture of 2.0 g of NaNO₃ (Aldrich), 10 g KMnO₄ of (Aldrich) and 96 mL of concentrated H₂SO₄ (Aldrich, 98%) at 50° C. for 15 hours. The resulting paste like mixture was poured into 400 g of ice followed by adding 30 mL of hydrogen peroxide (Aldrich, 30%). The resulting solution was then stirred at room temperature for 2 hours to reduce the manganese dioxide, then filtered through a filter paper and washed with DI water. The solid was collected and then dispersed in DI water with stirring, centrifuged at 6300 rpm for 40 minutes, and the aqueous layer was decanted. The remaining solid was then dispersed in DI water again and the washing process was repeated 4 times. The purified GO was then dispersed in 10 mL of DI water under sonication (power of 10 W) for 2.5 hours to get the GO dispersion (0.4 wt %) as GO-1.

Preparation of a Coating Mixture: A 10 mL of 2.5 wt % poly(acrylic acid) solution was prepared by dissolving poly(acrylic acid) (PAA) (2.5 g, Avg. Mv. ˜450,000, Aldrich) in DI water. Next, 0.1 mL of a 0.1 wt % aqueous solution of CaCl₂ (anhydrous, Aldrich) was added. Then, 0.21 mL of a 0.47 wt % of K₂B₄O₇ (Aldrich) was added and the resulting solution was stirred until well mixed to generate a crosslinker solution (XL-1). Then, GO-1 (10 mL) and XL-1 (8 mL) solutions were combined with 10 mL of DI water and sonicated for 6 minutes to ensure uniform mixing to create a coating solution (CS-1).

### Example 2.1.1: Preparation of a Membrane

Pretreat Substrate: A 7.6 cm diameter PET porous support, or substrate, (Hydranautics, San Diego, Calif. USA) was dipped into a 0.05 wt % PVA (Aldrich) in DI water solution. The substrate was then dried in oven (DX400, Yamato Scientific Co., Ltd. Tokyo, Japan) at 65° C. to yield a pretreated substrate.

Mixture Application: The coating mixture (CS-1) was then filtered through the pretreated substrate under gravity to draw the solution through the substrate such that a layer of about 500 nm thick of coating was deposited on the support. The resulting membrane was then placed in an oven (DX400, Yamato Scientific) at 110° C. for 30 minutes to facilitate crosslinking. This process generated a membrane without a salt rejection layer (MD-1.1.1.1).

### Example 2.1.1.1: Preparation of Additional Membranes

Additional membranes were constructed using the methods similar to Example 1.1.1 and Example 2.1.1, with the exception that parameters were varied as shown in Table 1. Specifically, individual concentrations were varied, and additional additives were added to the aqueous Coating Additive Solution (e.g., sodium lignosulfonate (2.5 g, CAS: 8061-51-6, S1854, Technical Grade, Spectrum Chemical), PVA (Aldrich), MPD (Aldrich), 3,5-diaminobenzoic acid (Aldrich), CaCl₂ (anhydrous, Aldrich), K₂B₄O₇ (Aldrich), TEOS (T) (Aldrich), 3-aminopropyltrimethoxysilane (S1) (Aldrich), 3-aminopropyltriethoxysilane (S2) (Aldrich), SiO₂ (5-15 nm, Aldrich), SiO₂ (10-20 nm, Aldrich), etc.). Additionally, for some embodiments a second-type of PET support (PET2) (Hydranautics, San Diego, Calif. USA) was used instead.

Where membranes were identified as coated with a die coating instead of filtration, the procedure was varied as follows. The coating solution was deposited on the membrane surface using a die caster (Taku-Die 200, Die-Gate Co., Ltd., Tokyo, Japan), which was set to create the desired coating thickness.

TABLE 1
Membranes Made without a Salt Rejection Layer.

| | | | Additional | | | Additives | | |
|---|---|---|---|---|---|---|---|---|
| | | | Crosslinker | | | | Borate | TEOS/ |
| | GO | PAA | Lignin | PVA | MPD | PEG | Salt | Silane |
| Membrane | (wt %) | (wt %) | (wt %) | (wt %) | (wt %) | (wt %) | (wt %) | (wt %/Typ.) |
| MD-1.1.1.1 | 16.7 | 83.3 | — | — | — | — | — | — |
| MD-1.1.1.2 | 16.7 | 83.3 | — | — | — | — | — | — |
| MD-1.1.2.1 | 15.4 | 76.9 | — | — | — | — | — | 7.7/T |
| MD-1.1.3.1 | 13.8 | 69.0 | — | — | 17.2 | — | — | — |
| MD-1.1.4.1 | 14.3 | 57.1 | 28.6 | — | — | — | — | — |
| MD-1.1.5.1 | 14.8 | 74.1 | — | — | — | — | — | 7.4/T |
| MD-1.1.6.1 | 13.3 | 50.0 | 26.7 | — | — | — | — | 6.7/T |
| MD-1.1.7.1 | 13.8 | 51.7 | 27.6 | — | — | — | — | — |
| MD-1.1.7.2 | 13.8 | 51.7 | 27.6 | — | — | — | — | — |
| MD-1.1.7.3 | 13.8 | 51.7 | 27.6 | — | — | — | — | — |
| MD-1.1.8.1 | 25.0 | 46.9 | 25.0 | — | — | — | — | — |
| MD-1.1.9.2 | 15.6 | 77.7 | — | — | — | — | — | — |
| MD-1.1.10.2 | 15.6 | 77.7 | — | — | — | — | — | — |
| MD-1.1.11.2 | 14.6 | 72.8 | — | — | — | — | — | 6.3/S1 |
| MD-1.1.12.2 | 14.6 | 72.8 | — | — | — | — | — | 6.3/S1 |
| MD-1.1.13.1 | 20 | 50 | — | — | — | 10 | — | 10/S1 |
| MD-1.1.14.1 | 34 | 66 | — | — | — | — | — | — |
| CMD-1.1.1.1 | 13.2 | — | — | 76.7 | — | — | 10.1 | — |
| CMD-1.1.1.2 | 16.7 | — | — | 83.3 | — | — | — | — |

| | Additives | | | | Curing | |
|---|---|---|---|---|---|---|
| | Nano-Silica | | Coating | Thickness | Temp | Time |
| Membrane | (wt %/nm) | Support | Method | (nm) | (° C.) | (min) |
| MD-1.1.1.1 | — | PET | Filtration | 500 | 110 | 30 |
| MD-1.1.1.2 | — | PET | Die Coat | 3000 | 110 | 30 |
| MD-1.1.2.1 | — | PET | Filtration | 500 | 110 | 30 |
| MD-1.1.3.1 | — | PET | Filtration | 500 | 110 | 30 |
| MD-1.1.4.1 | — | PET | Filtration | 500 | 110 | 30 |
| MD-1.1.5.1 | 3.7/7 | PET | Filtration | 500 | 110 | 30 |
| MD-1.1.6.1 | 3.3/7 | PET | Filtration | 500 | 110 | 30 |
| MD-1.1.7.1 | 6.9/7 | PET | Filtration | 500 | 110 | 30 |
| MD-1.1.7.2 | 6.9/20 | PET | Filtration | 500 | 110 | 30 |
| MD-1.1.7.3 | 6.9/20 | PET | Filtration | 500 | 110 | 30 |
| MD-1.1.8.1 | 3.1/20 | PET | Filtration | 1000 | 110 | 30 |
| MD-1.1.9.2 | 6.7/7 | PET | Die Coat | 3000 | 110 | 30 |
| MD-1.1.10.2 | 6.7/20 | PET | Die Coat | 3000 | 110 | 30 |
| MD-1.1.11.2 | 6.3/7 | PET | Die Coat | 3000 | 110 | 30 |
| MD-1.1.12.2 | 6.3/20 | PET | Die Coat | 3000 | 110 | 30 |
| MD-1.1.13.1 | 10/40 | nylon | Die Coat | 1000 | 140 | 6 |
| MD-1.1.14.1 | — | polypropylene | Die Coat | 30 | 100 | 3 |
| CMD-1.1.1.1 | — | PET2 | Die Coat | 225 | 140 | 6 |
| CMD-1.1.1.2 | — | PET | Die Coat | 3000 | 140 | 6 |

Note:
Membrane Numbering Scheme is MD/CMD-J.K.L.M, wherein
J = 1 - no salt rejection layer; 2 - salt rejection layer
K = 1 - no protective coating; 2 - protective coating
L = category of membrane
M = membrane # within category

### Example 2.2.1: Addition of a Salt Rejection Layer to a Membrane

To enhance the salt rejection capability of the membrane, MD-1.1.1.2 was additionally coated with a polyamide salt rejection layer. A 3.0 wt % m-Phenylenediamine (MPD) aqueous solution was prepared by diluting an appropriate amount of MPD (Aldrich) in DI water. A 0.14 vol % trimesoyl chloride solution was made by diluting an appropriate amount of trimesoyl chloride (Aldrich) in isoparrif in solvent (Isopar E & G, Exxon Mobil Chemical, Houston Tex., USA). The membrane of MD-1.1.1.2 was then dipped in the aqueous solution of 3.0 wt % of MPD (Aldrich) for a period of 10 seconds to 10 minutes depending on the substrate and then removed. Excess solution remaining on the membrane was then removed by air drying. Then, the membrane was dipped into the 0.14 vol % trimesoyl chloride solution for 10 seconds and removed. The resulting assembly was then dried in an oven (DX400, Yamato Scientific) at 120° C. for 3 minutes. This process resulted in a GO-MPD coated membrane with a salt rejection layer (MD-2.1.1.2).

### Example 2.2.1.1: Addition of a Salt Rejection Layer to Additional Membranes

Additional selected membranes were coated with a salt rejection layer using a similar procedure as that in Example 2.2.1. The resulting configurations of the new membranes are presented in Table 2.

TABLE 2
Membranes with a Salt Rejection Layer

| | | | | | | | | | TEOS/ | Nano, | | |
|---|---|---|---|---|---|---|---|---|---|---|---|---|
| | | | | | | | | Borate | Silane | Silica | | Thick- |
| | GO | PAA | Lignin | PVA | MPD | CaCl₂ | PEG | Salt | (wt %/ | (wt %/ | Sup- | ness |
| Membrane^{[1]} | (wt %) | (wt %) | (wt %) | (wt %) | (wt %) | (wt %) | (wt %) | (wt %) | Typ.) | nm) | port | (μm) |
| MD-2.1.1.2 | 16.7 | 83.3 | — | — | — | — | — | — | — | — | PET | 3 |
| MD-2.1.9.2 | 15.6 | 77.7 | — | — | — | — | — | — | — | 6.7/7 | PET | 3 |
| MD-2.1.10.2 | 15.6 | 77.7 | — | — | — | — | — | — | — | 6.7/20 | PET | 3 |
| MD-2.1.11.2 | 14.6 | 72.8 | — | — | — | — | — | — | 6.3/S1 | 6.7/7 | PET | 3 |
| MD-2.1.12.2 | 14.6 | 72.8 | — | — | — | — | — | — | 6.3/S1 | 6.7/20 | PET | 3 |
| MD-2.2.13.1 | 20.0 | 50.0 | — | — | — | — | 10 | — | 10/S1 | 10/40 | Nylon | 1 |
| MD-2.2.14.1 | 34.0 | 66.0 | — | — | — | — | — | — | — | — | PPE | 0.03 |
| CMD-2.1.1.2 | 16.7 | — | — | 83.3 | — | — | — | — | | — | PET | 3 |

Note:
^{[1]}Membrane Numbering Scheme is CMD/MD-J.K.L.M, wherein
J = 1 - no salt rejection layer; 2 - salt rejection layer
K = 1 - no protective coating; 2 - protective coating
L = category of membrane
M = membrane # within category

### Example 2.2.2: Preparation of a Membrane with a Protective Coating (Prophetic)

Any of the membranes can be coated with protective layers. First, a PVA solution of 2.0 wt % can be prepared by stirring 20 g of PVA (Aldrich) in 1 L of DI water at 90° C. for 20 minutes until all the granules dissolved to form a PVA solution. The PVA solution can then be cooled to room temperature. The selected substrates can be immersed in the PVA solution for 10 minutes and then removed. Excess solution remaining on the membrane can then be removed by paper wipes. The resulting assembly can then be dried in an oven (DX400, Yamato Scientific) at 90° C. for 30 minutes. A membrane with a protective coating can thus be obtained.

### Example 3.1: Performance Testing of Selected Membranes

Water Flux Testing: The water flux of GO-based membrane coated on varies porous substrates were found to be very high, which is comparable with the porous polysulfone substrate widely used in current reverse osmosis membranes.

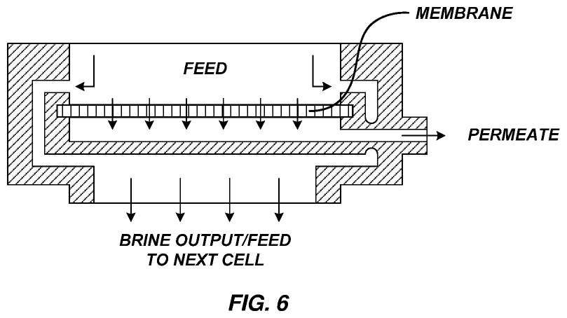

To test water flux, a membranes was first placed and secured in a laboratory test cell apparatus similar to the one shown in FIG. 6. The membrane was then exposed to a unprocessed fluid at a flow rate of 1.5 gpm and a gauge pressure of 50 psi. The water flux through the membrane was then left to stabilize for about 120 minutes. At 120 minutes of exposure of the membrane to the pressure of 50 psi, the water flux was then recorded (in units of gal·d⁻¹·ft⁻² or GFD). The water flux for various membranes were tested in the same way and the results are shown in Tale 3. As shown in Table 3, most membranes showed significantly higher water flux over a comparative membrane (e.g., MD-1.1.1.1, MD-1.1.2.1, MD-1.1.3.1, MD-1.1.4.1, MD-1.1.4.1, MD-1.1.5.1, MD-1.1.7.3, or MD-1.1.8.1 vs CMD-1.1.1.1). The data indicates that the GO-based membranes can withstand reverse osmosis pressures while providing sufficient water flux.

TABLE 3
Membrane Water Flux Performance.

| | Flux at |
|---|---|
| | 120 min^{[1]} |
| Membrane | (GFD) |
| GO-PAA (1:5 wt); PET; 500 μm | 9.2 |
| (MD-1.1.1.1) | |
| GO-PAA (2:11 wt) - 7.7 wt % TEOS; PET; 500 μm | 9.6 |
| (MD-1.1.2.1) | |
| GO-PAA/MPD (4:25 wt)(4:1 wt PAA:MPD); PET; 500 μm | 4.1 |
| (MD-1.1.3.1) | |
| GO-PAA/Lignin (1:6 wt)(2:1 wt PAA:Lignin); PET; 500 μm | 11.4 |
| (MD-1.1.4.1) | |
| GO-PAA (1:5 wt) - 7.4 wt % TEOS, 3.7 wt % SNP 7 nm; | 3.9 |
| PET; 500 μm | |
| (MD-1.1.5.1) | |
| GO-PAA/Lignin (4:23 wt)(15:8 wt PAA:Lignin) - 6.7 wt % | 2.2 |
| TEOS, 3.3 wt % SNP 7 nm; PET; 500 μm | |
| (MD-1.1.6.1) | |
| GO-PAA/Lignin (4:23 wt)(15:8 wt PAA:Lignin) - 6.9 wt % | 2.2 |
| SNP 20 nm; PET; 500 μm | |
| (MD-1.1.7.1) | |
| GO-PAA/Lignin (4:23 wt)(15:8 wt PAA:Lignin) - 6.9 wt % | 603^{[2]} |
| SNP 20 nm; PET; 500 μm | |
| (MD-1.1.7.2) | |
| GO-PAA/Lignin (4:23 wt)(15:8 wt PAA:Lignin) - 6.9 wt % | 6.7 |
| SNP 20 nm; PET; 500 μm | |
| (MD-1.1.7.3) | |
| GO-PAA/Lignin (8:23 wt)(15:8 wt PAA:Lignin) - 3.1 wt % | 43 |
| SNP 20 nm; PET; 1,000 μm | |
| (MD-1.1.8.1) | |
| GO-PVA (0.2:1.0 wt %) - 10% KBO; PET2; 225 μm | 2.0 |
| (CMD-1.1.1.1) | |

^{[1]}Cell Testing Conditions: pressure: 50 psi, temperature: 25° C., pH: 6.5-7.0, run flow: 1.5 gpm.
^{[2]}Embodiment had large pore defects.

Salt Rejection Testing: Measurements were done to characterize the membranes' salt rejection performance. The membranes were placed in a test cell, similar to the one described in FIG. 6, where the membranes were subjected to salt-solution of 1500 ppm NaCl at an upstream pressure of about 225 psi. The permeate flow rate and salt content was measured to determine the membranes' ability to reject salt and retain adequate water flux. The results are shown in Table 4.

TABLE 4
Membrane Salt Rejection Performance.

| | 1500 ppm | Flux at |
|---|---|---|
| | NaCl | 120 |
| | Rejection | min |
| Membrane | (%) | (GFD) |
| GO-PAA (1:5 wt); PET; 3 μm | 40.2 | 3.5 |
| (MD-2.1.1.2) | | |
| GO-PAA (1:5 wt) - 6.7 wt % SNP 7 nm; PET; | 8.6 | 205 |
| 3 μm (MD-2.1.9.2) | | |
| GO-PAA (1:5 wt) - 6.7 wt % SNP 20 nm; PET; | 16.2 | 95.6 |
| 3 μm (MD-2.1.10.2) | | |
| GO-PAA (1:5 wt) - 6.3 wt % Silane (S1), 6.3 | 28.7 | 8.6 |
| wt % SNP 7 nm; PET; 3 μm | | |
| (MD-2.1.11.2) | | |
| GO-PAA (1:5 wt) - 6.3 wt % Silane (S1), 6.3 | 78.6 | 1.2 |
| wt % SNP 20 nm; PET; 3 μm | | |
| (MD-2.1.12.2) | | |
| GO-PAA (20:5 wt) - 10 wt % PEG, 10 wt % | 90.0 | 2.0 |
| silane (S1), 10 wt % SNP 40 nm, nylon, 1 um | | |
| MD.2.2.13.1 | | |
| GO-PAA (1:2 wt), stretched polypropylene, 30 nm | 99.7 | 8.5 |
| MD-2.2.14.1 | | |
| GO-PVA (1:5 wt); PET; 225 μm | N/A | N/A |
| (CMD-1.1.1.1) | | |

Note:
Cell Testing Conditions: pressure: 225 psi, temperature: 25° C., pH: 6.5-7.0, run flow: 1.5 gpm.

Unless otherwise indicated, all numbers expressing quantities of ingredients, properties such as molecular weight, reaction conditions, and etc. used in herein are to be understood as being modified in all instances by the term “about.” Each numerical parameter should at least be construed in light of the number of reported significant digits and by applying ordinary rounding techniques. Accordingly, unless indicated to the contrary, the numerical parameters may be modified according to the desired properties sought to be achieved, and should, therefore, be considered as part of the disclosure. At the very least, the examples shown herein are for illustration only, not as an attempt to limit the scope of the disclosure.

The terms “a,” “an,” “the” and similar referents used in the context of describing embodiments of the present disclosure (especially in the context of the following claims) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illustrate embodiments of the present disclosure and does not pose a limitation on the scope of any claim. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Certain embodiments are described herein, including the best mode known to the inventors for carrying out the embodiments. Of course, variations on these described embodiments will become apparent to those of ordinary skill in the art upon reading the foregoing description. The inventor expects skilled artisans to employ such variations as appropriate, and the inventors intend for the embodiments of the present disclosure to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A water permeable membrane comprising:
a porous support; and
a composite coated on the porous support, comprising a crosslinked graphene oxide compound, wherein the crosslinked graphene oxide compound is formed by reacting a mixture comprising a graphene oxide compound and a crosslinker comprising a polycarboxylic acid;
wherein the graphene oxide compound is suspended within the crosslinker and the weight ratio of the graphene oxide compound to the crosslinker is at least 0.1; and
wherein the membrane exhibits a water flux which is greater than about 5 GFD, as determined by measuring the water flux after flowing water through the membrane at a pressure of 50 psi for 120 minutes.

2. The water permeable membrane of claim 1, wherein the support is a non-woven fabric comprising polyamide, polyimide, polyvinylidene fluoride, polyethylene, polyethylene terephthalate, polysulfone, polyether sulfone, stretched polypropylene, polyethylene or a combination thereof.

3. The water permeable membrane of claim 1, wherein the graphene oxide compound comprises a graphene oxide, reduced-graphene oxide, functionalized graphene oxide, functionalized and reduced-graphene oxide, or a combination thereof.

4. The water permeable membrane of claim 3, wherein the graphene oxide compound is graphene oxide.

5. The water permeable membrane of claim 1, wherein the crosslinker is a poly(acrylic acid).

6. The water permeable membrane of claim 1, wherein the crosslinker further comprises an additional crosslinker which comprises lignin, polyvinyl alcohol, meta-phenylenediamine, or a combination thereof.

7. The water permeable membrane of claim 6, wherein the lignin comprises one or more of a lignosulfonate salt comprising sodium lignosulfonate, calcium lignosulfonate, magnesium lignosulfonate, potassium lignosulfonate, or a combination thereof.

8. (canceled)

9. The water permeable membrane of claim 1, wherein the weight ratio of the crosslinker to the graphene oxide compound is about 0.5 to about 9.

10. The water permeable membrane of claim 1, wherein the composite further comprises an additive mixture comprising CaCl₂, borate salt, tetraethyl orthosilicate, an optionally substituted aminoalkylsilane, silica nanoparticles, polyethylene glycol or a combination thereof.

11. (canceled)

12. The water permeable membrane of claim 10, wherein the borate salt comprises K₂B₄O₇, Li₂B₄O₇, Na₂B₄O₇, or a combination thereof.

13. (canceled)

14. The water permeable membrane of claim, 10, wherein the tetraethyl orthosilicate is 0 wt % to about 10 wt % of the composite.

15. The water permeable membrane of claim, 10, wherein the optionally substituted aminoalkylsilane is 3-aminopropyltrimethoxysilane, 3-aminopropyltriethoxysilane, or a combination thereof.

16. (canceled)

17. The water permeable membrane of claim 10, wherein the silica nanoparticles are 0 wt % to about 10 wt % of the composite, and wherein the average size of the nanoparticles is about 5 nm to about 200 nm.

18. The water permeable membrane of claim 1, further comprising a salt rejection layer to reduce a salt permeability of the membrane, wherein the salt rejection layer comprises a polyamide prepared by reacting a mixture containing meta-phenylenediamine and trimesoyl chloride.

19. The water permeable membrane of claim 18, wherein the salt is NaCl.

20.-21. (canceled)

22. The water permeable membrane of claim 1, wherein the composite is a layer having a thickness of about 30 nm to about 3000 nm.

23. The water permeable membrane of claim 1, having a thickness of about 30 nm to about 4000 nm.

24.-26. (canceled)

27. The water permeable membrane of claim 1, having about 8% to about 100% rejection of NaCl at 225 psi pressure.

28.-34. (canceled)

35. A method of removing solute from an unprocessed solution comprising exposing the unprocessed solution to, or passing the unprocessed solution through, the water permeable membrane of claim 1.

36. (canceled)

37. The method of claim 35, wherein the unprocessed solution is passed through the water permeable membrane by applying a pressure gradient across the water permeable membrane.
